(19) United States
(12) Patent Application Publication
(10) Pub. No.: US 2021/0273795 A1
(43) Pub. Date: Sep. 2, 2021

(54) TRUSTED IMAGING

(71) Applicant: Seagate Technology LLC, Cupertino, CA (US)

(72) Inventors: Eric James Dahlberg, Eden Prairie, MN (US); Kevin Arthur Gomez, Eden Prairie (SG); Dan Mohr, Shakopee, MN (US); Daniel Joseph Klemme, Robbinsdale, MN (US)

(21) Appl. No.: 16/804,607

(22) Filed: Feb. 28, 2020

(51) Int. Cl. H04L 9/08; G06F 21/60; G06T 7/521

(52) U.S. Cl. CPC H04L 9/0869; G06T 2207/10028; G06T 7/521; G06F 21/602

(57) ABSTRACT

Systems and methods are disclosed for trusted imaging. In some examples, a trusted imaging device can emit a patterned light onto a real-world scene while an image sensor (e.g. photo or video) generates data representative of the real-world scene. The data can be processed to attempt to recover a pattern of the patterned light from the data. Whether, or to what extent, the pattern can be recovered can be determinative of a trustworthiness of the data from the image sensor. In further examples, the image data can be encrypted, as well as the imaging device output. In still further examples, a depth map of the image data can also be used to determine the trustworthiness of the image data.

### SUMMARY

In certain embodiments, an apparatus may comprise an image capture device including a light sensor configured to provide data representing an image of a scene to the image capture device and a light emitter configured to produce patterned light to be reflected off the scene and captured as part of the image of the scene. The apparatus may also comprise a data processing unit configured to recover the patterned light from the data and determine when the data is trustworthy based at least in part on the patterned light detected in the data and an output of the image capture device configured to provide the data at the output when the data has been deemed trustworthy.

In certain embodiments, a method may comprise emitting a patterned light onto a scene via a photo emitter configured to produce the patterned light and receiving, at an image sensor, image data representative of the scene. The method may also comprise processing, via a processor, the image data to attempt to recover the patterned light from the image data, and, when the patterned light is recovered from the image data, providing the image data as a trusted data output of an image capture device.

In certain embodiments, a device may comprise a data processing unit configured to receive image data from an image sensor, receive an indication of a first light pattern from a pattern generator, process the image data to obtain a second light pattern, compare the first light pattern to the second light pattern to determine a result, and determine whether the image data is trustworthy based on the result.

### BRIEF DESCRIPTION OF THE DRAWINGS

FIG. 1 is a diagram of a system of trusted imaging, in accordance with certain embodiments of the present disclosure;

FIG. 2 depicts a flowchart of an example method for trusted imaging, in accordance with certain embodiments of the present disclosure;

FIG. 3 depicts a flowchart of an example method for trusted imaging, in accordance with certain embodiments of the present disclosure;

FIG. 4 depicts a flowchart of an example method for trusted imaging, in accordance with certain embodiments of the present disclosure;

FIG. 5 depicts a flowchart of an example method for trusted imaging, in accordance with certain embodiments of the present disclosure; and

FIG. 6 is a diagram of light pattern examples, in accordance with certain embodiments of the present disclosure.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure.

In accordance with various embodiments, the methods and functions described herein may be implemented as one or more software programs running on a computer processor or controller. Dedicated hardware implementations including, but not limited to, application specific integrated circuits, programmable logic arrays, system-on-chip (SoC), and other hardware devices can likewise be constructed to implement the circuits, functions, processes, and methods described herein. Methods and functions may be performed by modules or engines, both of which may include one or more physical components of a computing device (e.g., logic, circuits, processors, controllers, etc.) configured to perform a particular task or job, or may include instructions that, when executed, can cause a processor to perform a particular task or job, or may be any combination thereof. Further, the methods described herein may be implemented as a computer readable storage medium or memory device including instructions that, when executed, cause a processor to perform the methods.

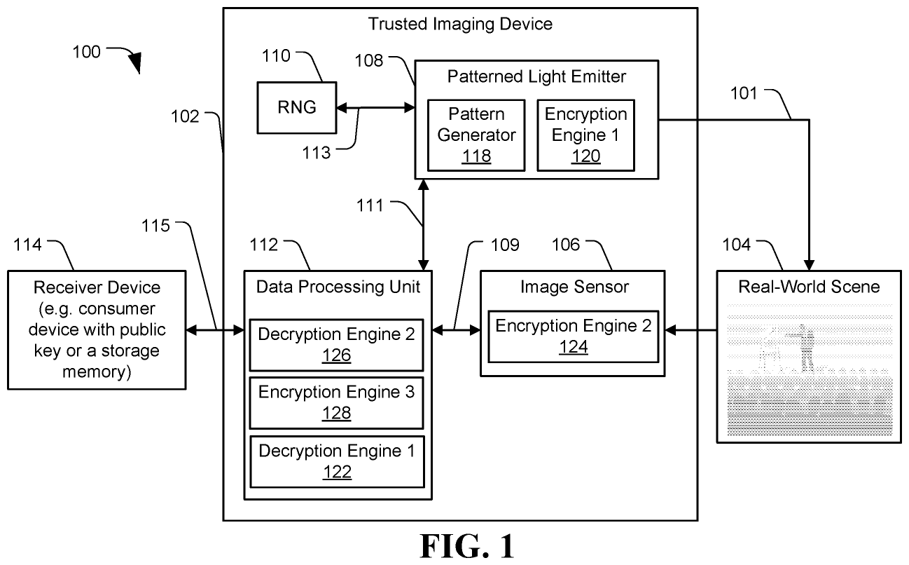

FIG. 1A shows a diagram of a system of trusted imaging 100, in accordance with certain embodiments of the present disclosure. The system 100 can include a trusted imaging device (TID) 102 that is configured to generate image data representative of a real-world scene 104 and provide some level of authentication of the image data to the receiver device 114. The trusted imaging device may be a camera, for photography, video, or both. The trusted imaging device 102 can include a random number generator module 110, a patterned light emitter 108 (e.g. projector), an image sensor 106, and a data processing unit 112. The patterned light emitter 108 may include a pattern generator 118, an encryption engine 120, or both. The image sensor 106 may include an encryption engine 124. The data processing unit 112 may include a decryption engine 122, another decryption engine 126, an encryption engine 128, or any combination thereof as applicable to the security level specifications of a particular system. Some examples of the image sensor 106 can be an image sensor circuit for a digital camera or digital video recorder, such as a charge-coupled device (CCD) sensor, an active-pixel sensor (CMOS), or another type of image sensor circuit.

The encryption and decryption engines provided as examples herein may be modified, or removed, based on a level of trust that a trusted imaging system is being designed to produce. The encryption and decryption engines may be part of a dedicated circuit or controller for encryption, such as a trusted platform module (TPM) controller, and may also be implemented on any programmable circuit or controller that can implement encryption and decryption algorithms. Any encryption schemes that meet the requirements of the TID 102 may be implemented.

During operation, the trusted imaging device 102 can record an image of a real-world scene 104, such as via a digital photograph or video, while providing an output 113 that can include a level of authentication of the data representing the real-world scene. The output 113 may be provided to a memory device for storage or may be provided to another device 114, such as for further processing, dissemination, or display. The trusted imaging device 102 can include one or more trust, authentication, or encryption systems for preventing data corruption from adversarial attacks to image capture devices. Thus, the trusted imaging device 102 can prevent providing falsified images from adversarial attacks.

The patterned light emitter, or photo emitter, 108 can be a circuit or device that can produce patterned light 101 to be projected onto and reflected off the real-world scene 104. Some examples of such light emitters can be light emitting diodes, structured light projectors, lasers, digital light projectors, other light projectors, or a combination thereof.

The patterned light can be generated using several different techniques, such as a laser and microelectromechanical systems (MEMS) mirror scanner, laser interference, projection through or reflection from a spatial light modulator, vertical-cavity surface-emitting laser (VCSEL), light emitting diode (LED) structured light pattern projector, or other illuminating systems. The patterned light emitted may be any of the possible wavelengths across the electromagnetic spectrum, including, but not limited to, radio, infrared, visible, or ultraviolet, and may selected based on the application of the system 100.

The pattern of the patterned light 101 may be determined by a pattern generator 118, such as a structured light pattern generator circuit or chip, based on a random number 113 generated from the random number generator (RNG) 110. The pattern generator 118, the RNG 110, or both, may be a part of the light emitter 108 or may be separate components of the imaging device 102. The pattern may be encrypted by encryption engine 120 and provided from the pattern generator 118, or the light emitter 108, to the data processing unit 112 via output/input interface 111 configured to allow communication between the transmitting device and the data processing unit 112. The RNG 110 may provide a true random number, or pseudo-random number, to the pattern generator 118.

The pattern may be randomly or periodically changed to a different pattern. The change to a different pattern may be based on any combination of one or more of the following triggers: a new random number generated by the RNG 110, a new image capture being activated, a pre-determined period of time, a randomized period of time, a detection of compromised or questionable by the data processing unit 112, each acquisition frame of the image capture device 102, a random number of acquisition frames of the image capture device 102, a change in the scene 104, and other triggers.

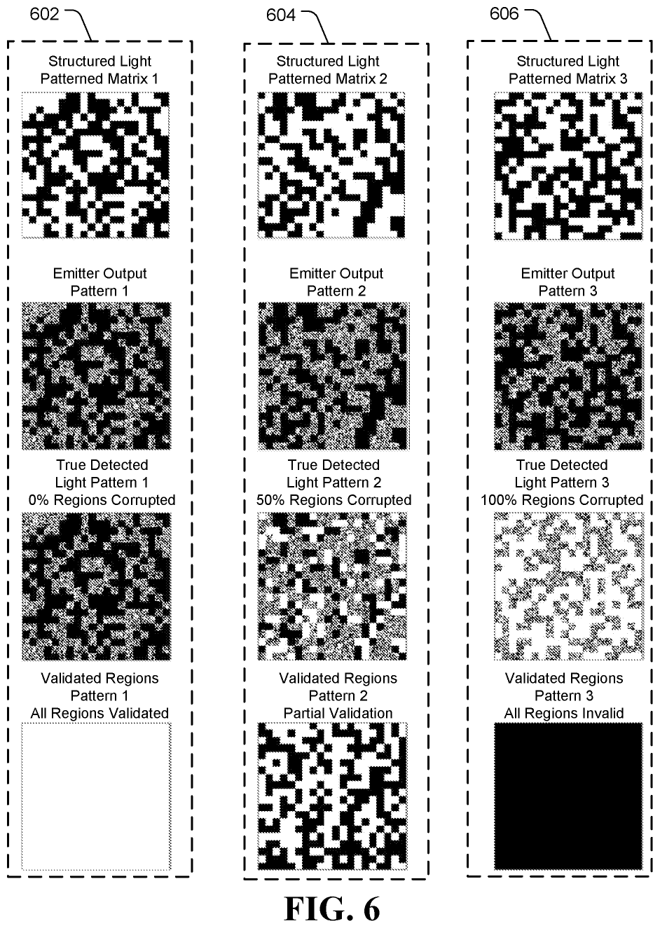

In some embodiments, a structured light pattern can be generated as an N×M matrix with values taken from a binary uniform distribution. Such a structured light pattern can be implemented by having a camera's field of view (e.g., the input to the image sensor 106) illuminated by the structured light emitter 108. To illustrate this, we can represent it as a matrix, such as shown in FIG. 6, where for each grid location corresponds to whether light is either emitted or not. A new matrix (e.g., patterned matrix 1, patterned matrix 2, and patterned matrix 3 in FIG. 6) can be used for different image captures. If the camera and emitter are located coaxially, the generated matrix can have a direct correspondence with the pixels of the camera where each grid element would correspond to one or more camera pixels. In the examples shown in FIG. 6, three sample matrices (e.g., in sample implementations 602, 604, and 606) are depicted where white indicates light illumination and black indicates no light added to the scene.

From the image data captured 109, the data processing unit 112 can attempt to recover the pattern 101. In some embodiments, the data processing unit 112 can also determine a depth map of the scene 104 from the image data 109. This can be accomplished using various depth enhancement techniques for illumination and image capture systems; for example, depth sensing can be accomplished using structured illumination systems. Images for which the pattern 101 can be recovered can give a level of trust that adversarial light signals have not been detected by the camera sensor 106 and the image data 109 has not been tampered with between the image sensor 106 and the data processing unit 112. Further, in some embodiments, the depth map can be used to verify that an adversarial device has not been placed in front of the camera sensor 106. A depth map of image data may be determined by a depth estimation to infer a relative distance between points of an image, for example, based on a triangular relationship between points of an image. In some examples, a depth map may represent the perpendicular distance between an object and the plane of the scene camera.

Depth map information can add a level of protection but may not by itself be sufficient to provide a trust mechanism. However, adding a depth map capability to a trusted imaging device as described herein can detect an attack vector such as projecting high resolution video on a screen placed in front of the image sensor. The depth map of the image scene may be determined via a plurality of technologies, including but not limited to, lidar, sonar, structured light, etc. wherein distances from the image sensor to selected locations within the image field of view can be measured. From the depth map information, a validation can occur to determine if the detected image depth map matches expected positions of an object.

In some examples with image depth detection, one or more criterion may be specified for detecting the placement of a screen in front of the trusted imaging device. In such a case, the detector would determine a plane in front of the imaging device from the image depth map. Further, depth map data of the image scene can be collected via two or more different technologies and be compared for consistency. For example, LiDAR Depth Map and Camera Depth Estimation can both be implemented in the trusted imaging device and the depth analysis results can be compared for consistency to establish a trusted image.

In some embodiments, the image capture device 102 may include one or more encryption engines, such as encryption engines 120, 124, and 128. For example, encryption engine 120 may encrypt the data representing the pattern when it is provided to the data processing unit 112, which may include decryption engine 122 configured to decrypt the encrypted pattern data. Further, the image sensor 106 may include encryption engine 124 configured to encrypt the data 109 representing the real-world scene 104. The data processing unit 112 may also include decryption engine 126 configured to decrypt the encrypted image data 109. The encryption/decryption engine pairs may be built into the circuitry of the device they are encrypting the device for and may include a secure key storage to store a private key.

In further embodiments, the system 102 may include an output 115 that provides encrypted data to another device or system 114. In some examples, the data processing unit 112 can include an encryption engine 128, which may be an asymmetric cryptographic system that has one or more public and private keys. The camera sensor data processing unit 112, upon receiving the secure transmission 109 from the camera sensor 106 and validating the data, can recover the light pattern and, if applicable, a depth map from the image data. The data processing unit 112 can then generate a signature for the unencrypted image data, encrypt the image data using an asymmetric encryption scheme and then transmit or store the encrypted data along with a generated signature. In some systems, the receiving device 114 can validate that the data received is paired with a public key and a signature that was generated by the trusted device 102.

In further embodiments, if there is parallax between the camera and emitter, correspondence of the emitter output and the sensor input could be determined based on techniques for correcting for parallax. The light emitter 108 could also use lasers in device solutions where the target image distance extends beyond the range of incoherent light sources.

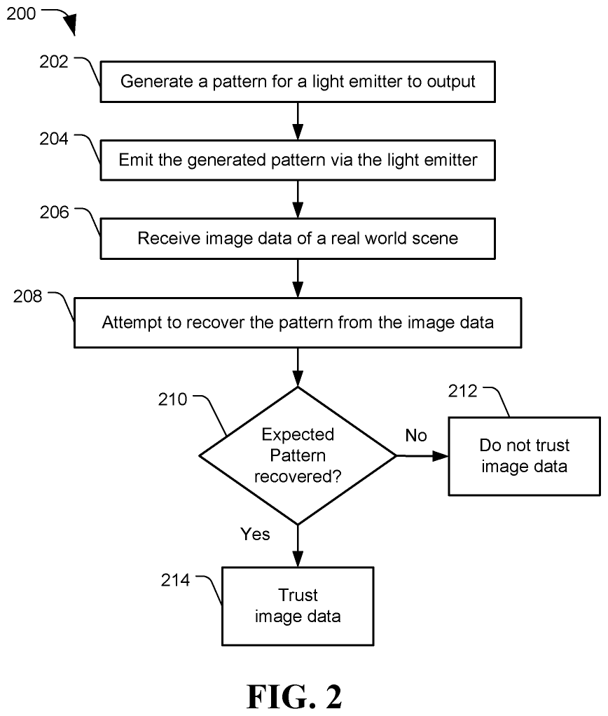

Referring to FIG. 2, a flowchart of an example method for trusted imaging, in accordance with certain embodiments of the present disclosure, is shown and generally designated 200. The method 200 may be used in conjunction with the systems of FIG. 1 and the other methods described herein.

Generally, method 200 may be utilized to produce trusted image data from a camera device, such as device 102. The method 200 may include generating a pattern for a light emitter, at 202, to output patterned light onto a scene, at 204. The patterned light may be received by the camera image sensor as part of the image data, at 206. A processing device, either within the image sensor or as a separate processing device, may attempt to recover the pattern from the image data, at 208. The processing device may also determine if the pattern was successfully recovered, at 210, such as by recovering an identical match to the pattern or a match within an acceptable amount of variation from the original pattern.

When the pattern data was successfully recovered, the method 200 may indicate the image data can be trusted, at 214. When the pattern data was not successfully recovered, the method 200 may indicate the image data cannot be trusted, at 212. Such may be indicated by setting an indicator (e.g. one or more bits in a table or metadata) that the image data is trusted or not trusted, whether the image data passed the pattern verification, or a similar indicator. In some embodiments, the data may be immediately deleted, quarantined, or put in a trash queue when the image cannot be trusted, at 212.

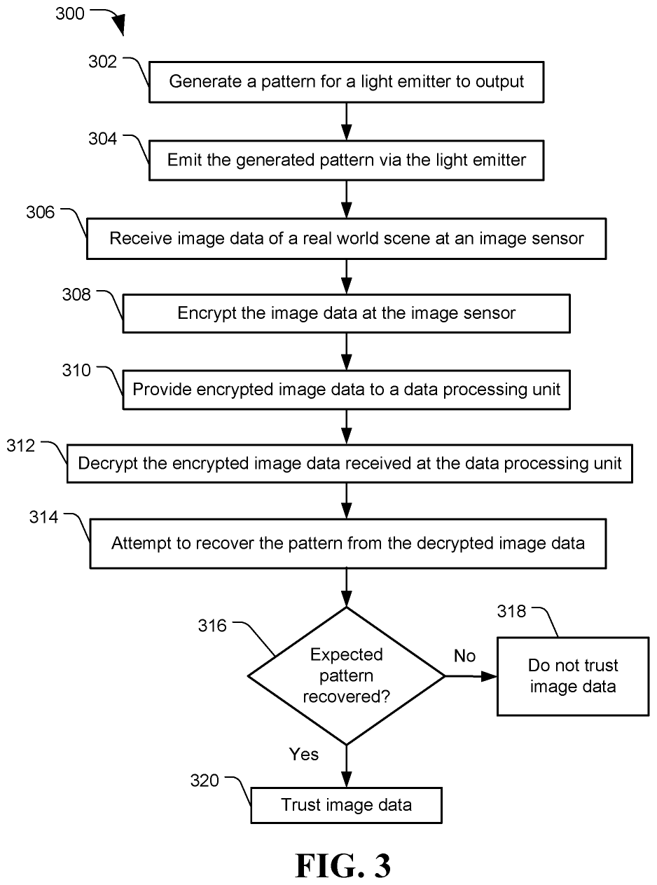

Referring to FIG. 3, a flowchart of an example method for trusted imaging, in accordance with certain embodiments of the present disclosure, is shown and generally designated 300. The method 300 may be used in conjunction with the systems of FIG. 1 and the other methods described herein.

Generally, method 300 may be utilized to produce trusted image data from a camera device, such as device 102. The method 300 may include generating a pattern for a light emitter, at 302, to output patterned light onto a scene, at 304. The patterned light may be received by the camera image sensor as part of the image data, at 306. An encryption engine may encrypt the image data at the image sensor, at 308, prior to the image data being provided to the data processing unit, at 310.

The data processing unit can decrypt the encrypted image data, at 312, and then attempt to recover the pattern from the image data, at 314. The processing device may also determine if the pattern was successfully recovered, at 316, such as by recovering an identical match to the pattern or a match within an acceptable amount of variation from the original pattern.

When the pattern data was successfully recovered, the method 300 may indicate the image data can be trusted, at 320. When the pattern data was not successfully recovered, the method 300 may indicate the image data cannot be trusted, at 318. Such may be indicated by setting an indicator (e.g. one or more bits in a table or metadata) that the image data is trusted or not trusted, whether the image data passed the pattern verification, or a similar indicator. In some embodiments, the data may be immediately deleted, quarantined, or put in a trash queue when the image cannot be trusted, at 318.

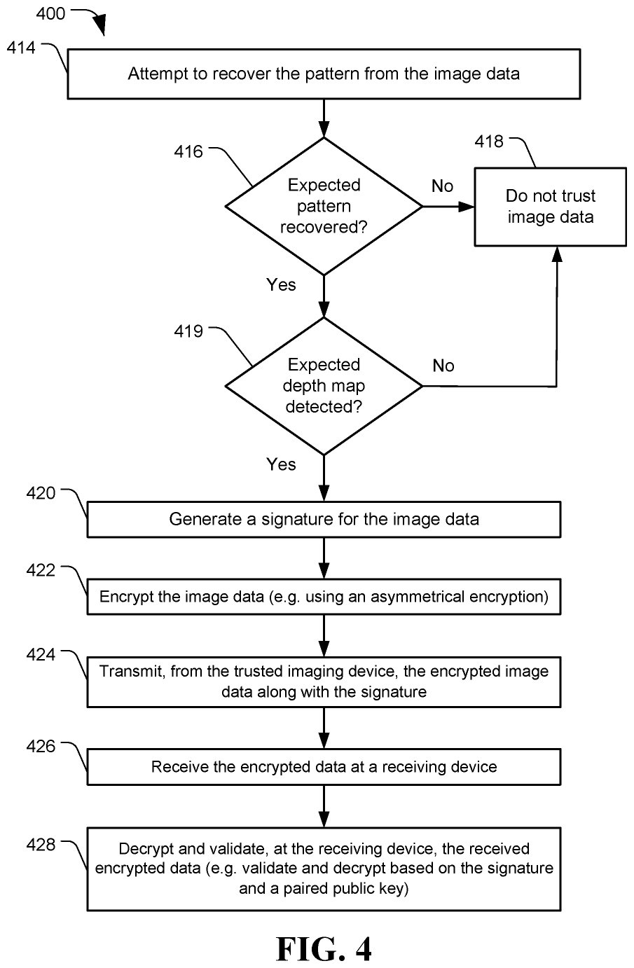

Referring to FIG. 4, a flowchart of an example method for trusted imaging, in accordance with certain embodiments of the present disclosure, is shown and generally designated 400. The method 400 may be used in conjunction with the systems of FIG. 1 and the other methods described herein.

A data processing unit can attempt to recover a pattern from image data, at 414. The processing device may also determine if the pattern was successfully recovered or validated, at 416, such as by recovering an identical match to the pattern or a match within an acceptable amount of variation from the original pattern. FIG. 6 provides examples 602, 604, and 606 of structured light pattern matrices, emitter outputs, detector inputs, and validation detections for three examples with different levels of corruption in the detected light pattern. Thus, acceptance or validation of a detected image may be implemented as a continuum, where partial validation is allowed, or a level of trust is determined based on a determined amount of corruption in the detected light pattern. A comparison algorithm can be utilized to verify that detected structured light pattern matches generated structured light pattern. Such a comparison algorithm can determine a relative amount, such as a percentage, of the detected light pattern that matches the generated structured light pattern. The TID 102 may implement one or more thresholds to determine whether the detected light pattern is a match to the expected light pattern or not.

For example, TID 102 may implement a threshold requirement of 80% or greater regions detected as not corrupted to indicate the detected image is valid; thus, applying this example to the example matrices provided in FIG. 6, example 604 and example 606 would not be validated by such a TID because they do not have 80% or greater of regions of the detected light pattern as not corrupted. However, if TID 102 was designed to set a threshold requirement at 50% or greater regions detected as not corrupted, then examples 602 and 604 would pass the threshold and their corresponding data would be indicated as valid while the data for example 606 would not be indicated as valid. Such a system may provide an output that indicates an image data is not valid, or the system may merely not provide a valid indicator without specifically indicating image data as not valid.

When the pattern data was not successfully recovered, the method 400 may indicate the image data cannot be trusted or perform another action, at 418. Such may be indicated by setting an indicator (e.g. one or more bits in a table or metadata) that the image data is trusted or not trusted, whether the image data passed the pattern verification, or a similar indicator. In some embodiments, the data may be immediately deleted, quarantined, or put in a trash queue when the image cannot be trusted, at 418.

When the pattern data was successfully recovered, the method 400 may, optionally, also determine whether an expected depth map of the image was detected, at 419. The data processing unit may determine a depth map from the image data and compare the depth map information to an expected depth map. When the expected depth map is not detected, the method 400 may indicate the image data cannot be trusted or perform another action, at 418. Such may be indicated by setting an indicator (e.g. one or more bits in a table or metadata) that the image data is trusted or not trusted, whether the image data passed the pattern verification, or a similar indicator. In some embodiments, the data may be immediately deleted, quarantined, or put in a trash queue when the image cannot be trusted, at 418. In some embodiments, the depth map analysis may be performed prior to the pattern data determination; for example, such may be useful if the depth map analysis can be done relatively faster as a first filter.

When the pattern data was successfully recovered and, if applicable, the depth map comparison was successful, the method 400 may generate a signature for the image data, at 420. In further embodiments, a digital signature may be generated based on asymmetric cryptography, at 420. The method 400 can also encrypt the image data using an asymmetric encryption engine, at 422. The encrypted image data can then be transmitted from the image capture device along with the signature, at 424. The transmission may be over a network, stored to a storage medium, or both.

A receiving or retrieving device may receive the encrypted image data, at 426, and decrypt and validate the image data, at 428. The validation and decryption may be accomplished utilizing the signature and a paired public key. A signature can be generated at any point before the data leaves the trusted imaging device. Each data hand-off between components (e.g., dedicated circuits or controllers) within the trusted imaging device can be encrypted to ensure that the data is secure. Typically, the signature is just for external verification and the signature generation is independent from the other portions of the data processing of the trusted imaging device.

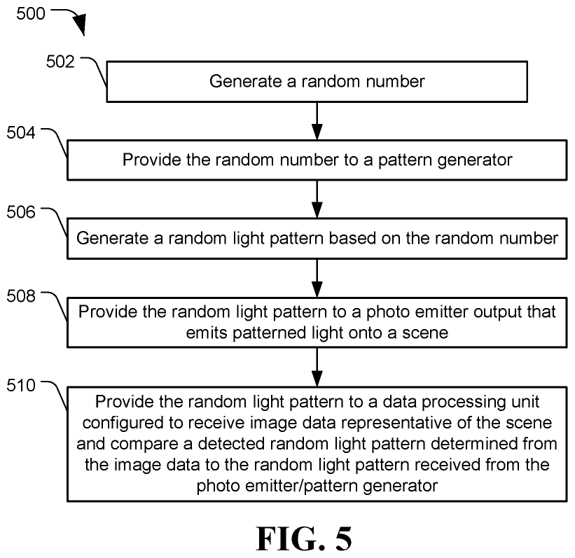

Referring to FIG. 5, a flowchart of an example method for trusted imaging, in accordance with certain embodiments of the present disclosure, is shown and generally designated 500. The method 500 may be used in conjunction with the systems of FIG. 1 and the other methods described herein.

Generally, the method 500 may be utilized to generate a random light pattern for use in the systems and methods described herein. The method 500 may generate a random number, at 502, such as via a random number generator. The random number may be provided to the light pattern generator, at 504. The random number may be a true random number or a pseudo-random number.

The light pattern generator may generate a random pattern based on the random number, at 506. The random pattern may then be provided to the photo emitter and output as a random light pattern onto a scene, at 508. The patterned light (or light pattern) can be generated using several different techniques, including, but not limited to, a laser and MEMS (microelectromechanical systems) mirror scanner, laser interference, projection through or reflection from a spatial light modulator, VCSEL laser, or other structured light emitting systems. The random pattern may be varied based on one or more triggers to provide different random patterns projected from the light emitter. The complexity and length of the random number encoded into the emitted light pattern may be chosen based on a variety of factors including a level of security a specific trusted imaging device is designed for.

The random light pattern may then be provided to a data processing unit configured to receive image data representative of the scene and compare a detected random light pattern determined from the image data to the random light pattern received from the photo emitter/pattern generator, at 510. The communication of the random light pattern from the pattern generator to the data processing unit may also be encrypted as described herein.

FIG. 6 provides examples 602, 604, and 606 of structured light pattern matrices, emitter outputs, detector inputs, and validation detections for three examples with different levels of corruption in the detected light pattern. These examples are applicable to any of the embodiments described herein. Further, acceptance or validation of a detected image may be implemented as a continuum that has varying levels of trust greater than a mere binary output, where partial validation is allowed or indicated. For example, a level of trust can be determined based on an amount of corruption in the detected light pattern.

In some examples, a trusted imaging device, such as TID 102, can output an indicator of a level of trust of an output, such as an indicator that represents or is correlated to a percentage of regions of the detected light pattern that were determined to be corrupted. There may also be a separate indicator for if a specific attack vector was detected, such as via the image depth map detection. The TID 102 may be designed to share an amount of trust information based on an expected use of the TID 102.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above embodiments can be made, and other embodiments not specifically described herein will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. An apparatus comprising:
an image capture device including:
a light sensor configured to provide data representing an image of a scene to the image capture device;
a light emitter configured to produce patterned light to be reflected off the scene and captured as part of the image of the scene; and
a data processing unit configured to recover the patterned light from the data and determine when the data is trustworthy based at least in part on the patterned light detected in the data; and
an output of the image capture device configured to provide the data at the output when the data has been deemed trustworthy.

2. The apparatus of claim 1 further comprising the light emitter includes a pattern generator configured to generate a random light pattern to be output as the patterned light.

3. The apparatus of claim 2 further comprising the pattern generator configured to generate the random light pattern based on a random number.

4. The apparatus of claim 3 further comprising a random number generator configured to generate the random number.

5. The apparatus of claim 1 further comprising the light emitter configured to communicate a light pattern of the patterned light to the data processing unit and the data processing unit configured to compare the light pattern received from the light emitter to a recovered light pattern from the data representing the image of the scene.

6. The apparatus of claim 1 further comprising:
the light sensor includes a first encryption engine configured to encrypt the data to produce first encrypted data, the light sensor configured to provide the first encrypted data to the data processing unit; and
the data processing unit includes a first decryption engine configured to decrypt the first encrypted data to produce the data.

7. The apparatus of claim 6 further comprising:
the data processing unit includes a second encryption engine configured to encrypt the data to produce second encrypted data when the patterned light matches an expected pattern, the data processing unit configured to provide the second encrypted data to an output of the image capture device.

8. The apparatus of claim 7 further comprising the second encryption engine configured to produce the second encrypted data is an asymmetric cryptographic system.

9. The apparatus of claim 7 further comprising:
the light emitter includes a third encryption engine configured to encrypt the expected pattern to produce an encrypted pattern, the light emitter configured to provide the encrypted pattern to the data processing unit; and
the data processing unit including a third decryption engine configured to recover the expected pattern from the encrypted pattern.

10. The apparatus of claim 1 further comprising the data processing unit configured to determine a depth map of the image of the scene from the data and determine when the data is trustworthy based at least in part on the depth map.

11. A method comprising:
emitting a patterned light onto a scene via a photo emitter configured to produce the patterned light;
receiving, at an image sensor, image data representative of the scene;
processing, via a processor, the image data to attempt to recover the patterned light from the image data; and
when the patterned light is recovered from the image data, providing the image data as a trusted data output of an image capture device.

12. The method of claim 11 further comprising generating the patterned light based on a random pattern that varies based on at least one condition.

13. The method of claim 11 further comprising:
encrypting, at the image sensor prior to providing the image data to the processor, the image data to produce encrypted image data;
providing the encrypted image data to the processor; and
decrypting, within the processor, the encrypted image data to recover the image data in an unencrypted form.

14. The method of claim 11 further comprising:
comparing a first pattern of the patterned light output by the photo emitter to a recovered pattern from the image data; and
when the comparison determines the first pattern matches the recovered pattern, indicating the image data is a trusted data output.

15. The method of claim 14 further comprising:
encrypting, at the processor, the image data to produce encrypted image data when the comparison determines the first pattern matches the recovered pattern; and
providing the encrypted image data via an output of the image capture device.

16. The method of claim 11 further comprising:
determining, via the processor, a depth map of the scene from the image data; and
determining whether the image data is trusted based on the depth map; and
when the image data is not trusted, not providing the image data as a trusted output of the image capture device.

17. A device comprising:
a data processing unit configured to:
receive image data from an image sensor;
receive an indication of a first light pattern from a pattern generator;
process the image data to obtain a second light pattern;
compare the first light pattern to the second light pattern to determine a result; and
determine whether the image data is trustworthy based on the result.

18. The device of claim 17 further comprising:
the image sensor configured to generate the image data from a real-world scene;
the pattern generator configured to determine the first light pattern randomly and provide the first light pattern to a light emitter;
the light emitter configured to project the first light pattern onto the real-world scene; and
the data processing unit including an interface to provide the image data to a device output.

19. The device of claim 18 further comprising:
the image sensor including a first encryption engine configured to encrypt the image data to produce first encrypted image data prior to providing the image data to the data processing unit; and
the data processing unit including a first decryption engine configured to decrypt the first encrypted image data.

20. The device of claim 19 further comprising:
the data processing unit including a second encryption engine configured to encrypt the image data, when the image data is determined to be trustworthy based on the result, to produce second encrypted image data; and
the data processing unit configured to provide the second encrypted image data to the device output.
